(19) United States
(12) Patent Application Publication
(10) Pub. No.: US 2007/0139369 A1
(43) Pub. Date: Jun. 21, 2007

(54) Portable electronic device and method for sharing a common display screen

(76) Inventor: Te-Yu Kao, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/384,786

(22) Filed: Mar. 21, 2006

(30) Foreign Application Priority Data
Dec. 19, 2005 (TW) 94145105

(51) Int. Cl. G09G 5/00

(52) U.S. Cl. 345/156

(57) ABSTRACT

A portable electronic device with a power saving function includes a portable electronic system, a DSC (Digital Still Camera) system and a transmission interface. The portable electronic system has a first process unit, the DSC system has a second process unit, and the transmission interface is electrically connected between the first process unit of the portable electronic system and the second process unit of the DSC system. Whereby, when using the DSC system, the portable electronic system switches into a power saving mold, and when needing to use the portable electronic system, the DSC system outputs a trigger signal to the portable electronic system via the transmission interface for waking the portable electronic system up.

### BACKGROUND OF THE INVENTION

1. Field of the Invention

The present invention relates to a portable electronic device and a method for sharing a common display screen, and particularly relates to a portable electronic system and a DSC system for sharing a common display system via a control right switching module.

2. Description of the Related Art

With the coming of the age of information technology, combined with the improvement of the Internet and other communication techniques, cell phones (or mobile phones) have become one of the most widespread communication tools. Cell phone products are loved and utilized by many consumers for their small size, lightweight, portability, numerous functions, and low price. People can send messages to their friends, family, or business associates immediately via their cell phone. As such, cell phones are more convenient and faster than traditional landline telephones. Cell phone users regularly receive and send information via wireless communication and can use text messages and emails to achieve this function.

Referring to FIG. 1, a first known mobile phone includes a mobile phone system 1a, a DSC (Digital Still Camera) system 2a electrically connected with the mobile phone system 1a, and a display screen 3a electrically connected with the mobile phone system 1a. Moreover, the mobile phone system 1a can show its relevant system information via the display screen 3a directly. With regard to display of the DSC system's relevant information, the DSC system 2a must transmit image data such as RGB data or raw data to a baseband CPU 10a of the mobile phone system 1a to perform image processes first, then, once the image data has been processed, it is transmitted to the display screen 3a for display.

Referring to FIG. 2, a second known mobile phone includes a media processor 4a electrically connected between the mobile phone system 1a and the DSC system 2a, and the display screen 3a is electrically connected with the media processor 4a. Hence, the DSC system 2a must transmit image data such as RGB data or raw data to the media processor 4a to perform image processes first, then the image data that has been processed is transmitted to the display screen 3a for display.

However, the known mobile phone still has some following defects:

1. System architecture is hard: because firmware of the known mobile phone is arranged in a memory of the baseband CPU 10a or the media processor 4a, the firmware needs to be rewritten or updated according to each type of mobile phone for conforming to the different needs of different mobile phones.

2. Image quality is bad: because the baseband CPU 10a or the media processor 4a usually processes the image data by a way of line buffer rather than by another way of optimization frame buffer, the image quality is bad.

3. The power consumption of the stand by currents of the DSC system 2a is high: if the DSC system does not work, the mobile phone system 1a still must supply power to the DSC system.

4. The DSC system cannot be upgraded because the DSC system's data process function is restricted by the image processing capability of the baseband CPU 10a or the media processor 4a, the known mobile phone's DSC system cannot keep pace with the technology of current digital cameras.

### SUMMARY OF THE INVENTION

The present invention provides a portable electronic device and a method for sharing a common display screen. The portable electronic device has a portable electronic system and a DSC system for sharing a common display system via a control right switching module. Hence the present has some advantages, as follows:

1. The firmware does not need to be rewritten or updated according to each type of mobile phone for conforming to the different needs of different mobile phones.

2. User can install a top-of-the-line digital camera to the portable electronic device such as a mobile phone or a PDA for obtaining better image quality.

3. When the DSC system does not work, the DSC system's power supply is cut off and the portable electronic system 1a does not supply power to the DSC system. Hence the power consumption of stand by currents of the DSC system is lower than that of known mobile phones.

4. The DSC system can be upgraded to current pixel and image quality. Moreover, the portable electronic system and the DSC system can be used separately, so that when portable electronic system has not been renewed, the DSC system can still be upgraded.

A first aspect of the present invention is a portable electronic device for sharing a common display screen. The portable electronic device comprises a display system, a portable electronic system and a DSC (Digital Still Camera) system. Both the portable electronic system and the DSC system are electrically connected with the display system. The portable electronic system and the DSC system have a first process unit and a second process unit, respectively. Whereby, the portable electronic system and the DSC system share the display system by switching a control right of the display system.

A second aspect of the present invention is a method of a portable electronic device sharing a common display screen, comprising: turning on a portable electronic system electrically connected with a display system for obtaining a control right of the display system; displaying relevant system information that is processed via a first process unit of the portable electronic system, via the display system; and, operating a control right switching module electrically connected with the portable electronic system, to switch the control right of the display system to a DSC system electrically connected with the display system for allowing the DSC system to obtain the control right of the display system.

Moreover, the method further comprises: displaying relevant video that is processed via a second process unit of the DSC system, via the display system; operating the control right switching module electrically connected with the DSC system for responding to a control signal to the portable electronic system; switching the control right of the display system to the portable electronic system via the control signal generated by the DSC system and transmitted to the portable electronic system for allowing the portable electronic system to obtain the control right of the display system again; and displaying, via the display system, other relevant system information that is processed by the first process unit of the portable electronic system.

A third aspect of the present invention is a method of a portable electronic device sharing a common display screen, comprising: turning on a portable electronic system electrically connected with a display system for obtaining a control right of the display system; displaying relevant system information that is processed via a first process unit of the portable electronic system, via the display system; and, switching the control right of the display system to a DSC system electrically connected with the display system via the portable electronic system for allowing the DSC system to obtain the control right of the display system;

Moreover, the method further comprises: displaying relevant video that is processed via a second process unit of the DSC system, via the display system; switching the control right of the display system to the portable electronic system by a control signal generated by the DSC system and transmitted to the portable electronic system for allowing the portable electronic system to obtain the control right of the display system again; and displaying, via the display system, other relevant system information that is processed via the first process unit of the portable electronic system.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a function block diagram of a mobile phone for sharing a common display according to one prior art;

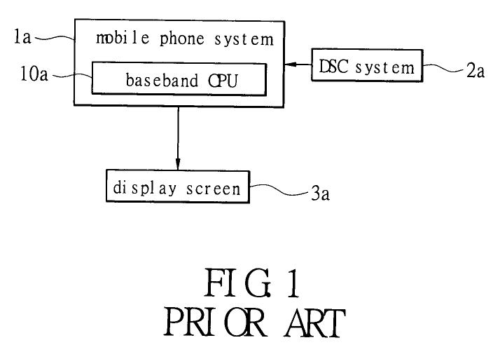

FIG. 2 is a function block diagram of a mobile phone for sharing a common display according to another prior art;

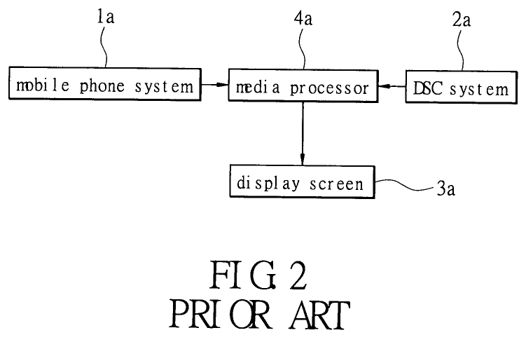

FIG. 3 is a function block diagram of a portable electronic device for sharing a common display screen according to the present invention; and

FIG. 4 is a flowchart of a method of a portable electronic device sharing a common display screen according to the first embodiment of the present invention; and

FIG. 5 is a flowchart of a method of a portable electronic device sharing a common display screen according to the second embodiment of the present invention.

### DETAILED DESCRIPTION OF PREFERRED BEST MOLDS

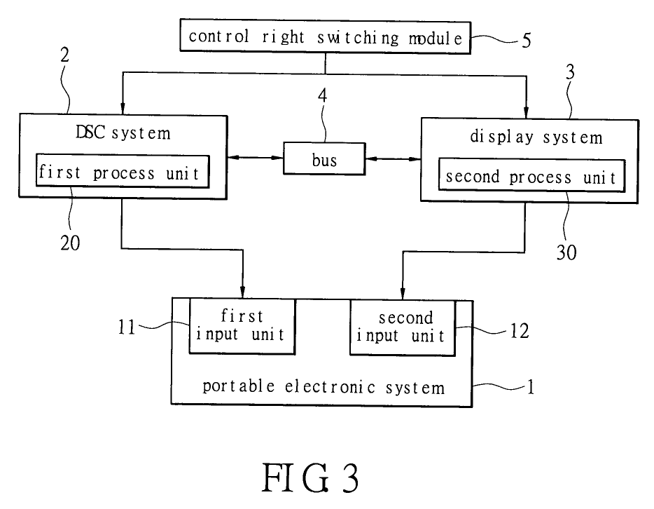

Referring to FIG. 3, the present invention provides a portable electronic device for sharing a common display screen. The portable electronic device comprises a display system 1, a portable electronic system 2, and a DSC (Digital Still Camera) system 3.

The display system 1 can be a display panel with two channels and has a first input unit 11 and a second input unit 12. Moreover, the portable electronic system 2 is electrically connected with the display system 1 via the first input unit 11, and the DSC system 3 is electrically connected with the display system 1 via the second input unit 12. In addition, the first input unit can be a system information input unit for receiving system information from the portable electronic system or the DSC system, and the second input unit can be a video input unit for receiving video from the portable electronic system or the DSC system.

Moreover, the portable electronic system 2 has a first process unit 20 and the DSC system 3 has a second process unit 30. In addition, the portable electronic system 2 is electrically connected with the DSC system via a bus 4. The bus 4 can be an I²C (Inter-Integrated Circuit) bus or any type of transmission line.

Furthermore, according to different demands, the portable electronic system 2 can be a mobile phone system, a PDA phone system, or a PDA system. In addition, both the first process unit 20 and the second process unit 30 can be a baseband CPU, a media processor, an application processor or any other type of processor.

In addition, the portable electronic device further comprises a control right switching module 5 electrically connected with both the portable electronic system 2 and the DSC system 3. The control right switching module 5 is used to switch the portable electronic system 2 or the DSC system 3 to obtain a control right of the display system 1. Moreover, the control right of the display system 1 is switched by pressing the control right switching module 5, opening or closing a lens cover (not shown) of the portable electronic device, or switching a switch (not shown) of the portable electronic device. However, the above-mentioned disclosed methods for switching the control right of the display system 1 should not be limiting of the present invention.

Hence, according to the above-mentioned technology means, the portable electronic system 2 and the DSC system 3 share the display system 1 by switching the control right of the display system 1.

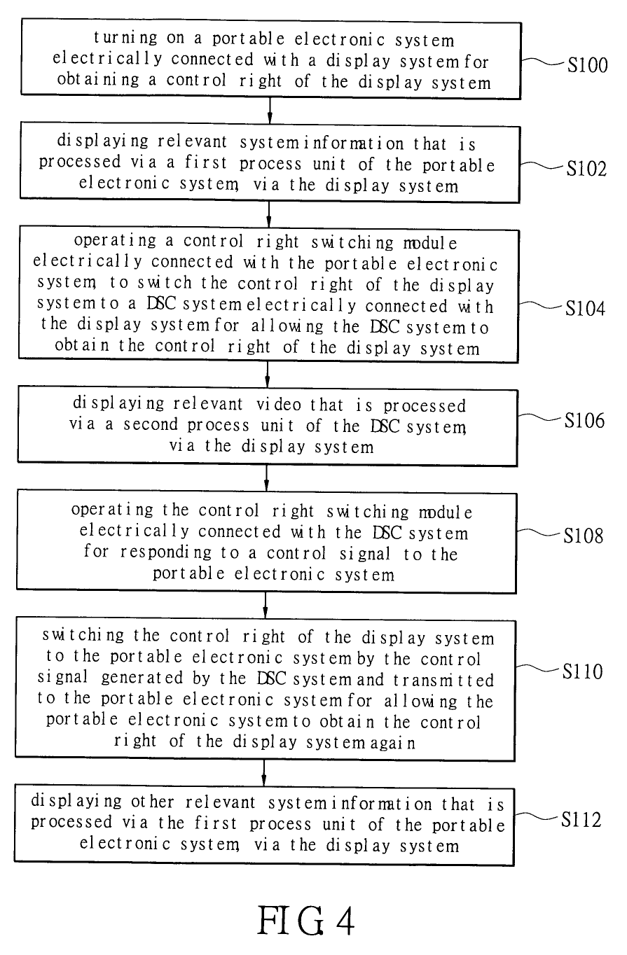

Referring to FIG. 4, the first embodiment of the present invention provides a method of a portable electronic device sharing a common display screen. The steps of the method comprise: firstly, turning on a portable electronic system 2 electrically connected with a display system 1 for obtaining a control right of the display system 1 (S100); next, displaying relevant system information that is processed via a first process unit 20 of the portable electronic system 2, via the display system 1 (S102).

Moreover, the method further comprises: operating a control right switching module 5 electrically connected with the portable electronic system 2, to switch the control right of the display system 1 to a DSC system 3 electrically connected with the display system 1 for allowing the DSC system 3 to obtain the control right of the display system 1 (S104); next, displaying relevant video that is processed via a second process unit 30 of the DSC system 3, via the display system 1 (S106); and then, operating the control right switching module 5 electrically connected with the DSC system 3 for responding to a control signal to the portable electronic system 2 (S108). In addition, the DSC system 3 responds to the control signal to the portable electronic system 2 via the bus 4.

Furthermore, the method further comprises: switching the control right of the display system 1 to the portable electronic system 2 by the control signal generated by the DSC system 3 and transmitted to the portable electronic system 2 for allowing the portable electronic system 2 to obtain the control right of the display system 1 again (S110); and then displaying other relevant system information that is processed via the first process unit 20 of the portable electronic system 2, via the display system 1 (S112).

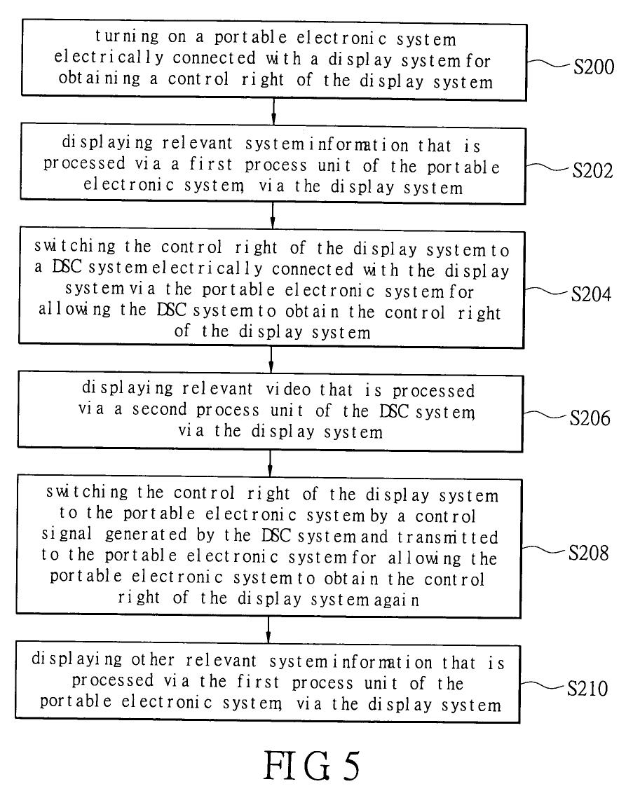

Referring to FIG. 5, the second embodiment of the present invention provides a method of a portable electronic device sharing a common display screen. The steps of the method comprises: firstly, turning on a portable electronic system 2 electrically connected with a display system 1 for obtaining a control right of the display system 1 (S200); and then, displaying relevant system information that is processed via a first process unit 20 of the portable electronic system 2, via the display system 1 (S202).

Moreover, the method further comprises: switching the control right of the display system 1 to a DSC system 3 electrically connected with the display system 1 via the portable electronic system 2 for allowing the DSC system 3 to obtain the control right of the display system 1 (S204); and then, displaying relevant video that is processed via a second process unit 30 of the DSC system 3, via the display system 1 (S206).

Furthermore, the method further comprises: switching the control right of the display system 1 to the portable electronic system 2 by a control signal generated by the DSC system 3 and transmitted to the portable electronic system 2 for allowing the portable electronic system 2 to obtain the control right of the display system 1 again (S208); finally, displaying other relevant system information that is processed via the first process unit 20 of the portable electronic system 2, via the display system 1 (S210).

In conclusion, the portable electronic system 2 and the DSC system 3 share the common display system 1 via the control right switching module 5. Hence the present invention has the following advantages:

1. The system architecture is simple: because the DSC system 3 is electrically connected with the portable electronic system 2, such as a mobile phone or a PDA, directly, the firmware does not need to be rewritten or updated according to each type of mobile phone for conforming to different needs of different mobile phones.

2. Image quality is perfect: because the DSC system 3 is electrically connected with the portable electronic system 2, such as a mobile phone or a PDA, directly, users can install a top-of-the-line digital camera to the portable electronic system 2 such as a mobile phone or a PDA for obtaining good image quality.

3. The power consumption of stand by currents of the DSC system 3 is lower: because the DSC system 3 is electrically connected with the portable electronic system 2, such as a mobile phone or a PDA, directly, the DSC system's power supply is cut off and the portable electronic system 2 does not supply power to the DSC system 3 when the DSC system 3 does not work. Hence the power consumption of stand by currents of the DSC system 3 is lower than that of known mobile phones.

4. The DSC system 3 can be upgraded to current digital cameras: because the DSC system 3 is electrically connected with the portable electronic system 2, such as a mobile phone or a PDA, directly, the DSC system 3 can be upgraded to current pixel and image quality. Moreover, the portable electronic system 2 and the DSC system 3 can be used separately, so that when portable electronic system 2 has not be renewed, the DSC system 3 can still be upgraded.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A portable electronic device for sharing a common display screen, comprising:
a display system;
a portable electronic system electrically connected with the display system and having a first process unit; and
a DSC (Digital Still Camera) system electrically connected with the display system and having a second process unit;
whereby, the portable electronic system and the DSC system share the display system by switching a control right of the display system.

2. The portable electronic device as claimed in claim 1, wherein the display system has a first input unit and a second input unit, and the portable electronic system is electrically connected with the display system via the first input unit and the DSC system is electrically connected with the display system via the second input unit.

3. The portable electronic device as claimed in claim 2, wherein the first input unit is a system information input unit for receiving system information from the portable electronic system or the DSC system, and the second input unit is a video input unit for receiving video from the portable electronic system or the DSC system.

4. The portable electronic device as claimed in claim 1, wherein the first process unit is a baseband CPU, a media processor, or an application processor, and the second process unit is a baseband CPU, a media processor, or an application processor.

5. The portable electronic device as claimed in claim 1, further comprising a control right switching module for switching the portable electronic system or the DSC system to obtain the control right of the display system, wherein the control right switching module is electrically connected with both portable electronic system and the DSC system.

6. The portable electronic device as claimed in claim 5, wherein the control right of the display system is switched by pressing the control right switching module, opening or closing a lens cover of the portable electronic device, or switching a switch of the portable electronic device.

7. The portable electronic device as claimed in claim 1, further comprising a bus electrically connected between the portable electronic system and the DSC system.

8. The portable electronic device as claimed in claim 7, wherein the bus is an I²C (Inter-Integrated Circuit) bus.

9. A method of a portable electronic device sharing a common display screen, comprising:
turning on a portable electronic system electrically connected with a display system for obtaining a control right of the display system;
displaying relevant system information that is processed via a first process unit of the portable electronic system, via the display system;
operating a control right switching module electrically connected with the portable electronic system, to switch the control right of the display system to a DSC system electrically connected with the display system for allowing the DSC system to obtain the control right of the display system;
displaying relevant video that is processed via a second process unit of the DSC system, via the display system;
operating the control right switching module electrically connected with the DSC system for responding to a control signal to the portable electronic system;
switching the control right of the display system to the portable electronic system by the control signal generated by the DSC system and transmitted to the portable electronic system for allowing the portable electronic system to obtain the control right of the display system again; and
displaying other relevant system information that is processed via the first process unit of the portable electronic system, via the display system.

10. The method as claimed in claim 9, wherein the display system has a first input unit and a second input unit, and the portable electronic system is electrically connected with the display system via the first input unit and the DSC system is electrically connected with the display system via the second input unit.

11. The method as claimed in claim 10, wherein the first input unit is a system information input unit for receiving system information from the portable electronic system or the DSC system, and the second input unit is a video input unit for receiving video from the portable electronic system or the DSC system.

12. The method as claimed in claim 9, wherein the first process unit is a baseband CPU, a media processor, or an application processor, and the second process unit is a baseband CPU, a media processor, or an application processor.

13. The method as claimed in claim 9, wherein the control right of the display system is switched by pressing the control right switching module, opening or closing a lens cover of the portable electronic device, or switching a switch of the portable electronic device.

14. The method as claimed in claim 9, further comprising a bus electrically connected between the portable electronic system and the DSC system, wherein the DSC system responds to the control signal to the portable electronic system via the bus.

15. The method as claimed in claim 14, wherein the bus is an I²C (Inter-Integrated Circuit) bus.

16. A method of a portable electronic device sharing a common display screen, comprising:
turning on a portable electronic system electrically connected with a display system for obtaining a control right of the display system;
displaying relevant system information that is processed via a first process unit of the portable electronic system, via the display system;
switching the control right of the display system to a DSC system electrically connected with the display system via the portable electronic system for allowing the DSC system to obtain the control right of the display system;
displaying relevant video that is processed via a second process unit of the DSC system, via the display system;
switching the control right of the display system to the portable electronic system by a control signal generated by the DSC system and transmitted to the portable electronic system for allowing the portable electronic system to obtain the control right of the display system again; and
displaying other relevant system information that is processed via the first process unit of the portable electronic system, via the display system.

17. The method as claimed in claim 16, wherein the display system has a first input unit and a second input unit, and the portable electronic system is electrically connected with the display system via the first input unit and the DSC system is electrically connected with the display system via the second input unit; wherein the first input unit is a system information input unit for receiving system information from the portable electronic system or the DSC system, and the second input unit is a video input unit for receiving video from the portable electronic system or the DSC system.

18. The method as claimed in claim 16, wherein the first process unit is a baseband CPU, a media processor, or an application processor, and the second process unit is a baseband CPU, a media processor, or an application processor.

19. The method as claimed in claim 16, further comprising a bus electrically connected between the portable electronic system and the DSC system, wherein the DSC system responds to the control signal to the portable electronic system via the bus.

20. The method as claimed in claim 19, wherein the bus is an I²C (Inter-Integrated Circuit) bus.
